(19) United States
(12) Patent Application Publication
(10) Pub. No.: US 2017/0285937 A1
(43) Pub. Date: Oct. 5, 2017

(54) SYSTEM USING ACCIDENT SCENARIO AND CODED SHORTCUT KEYS TO RAPIDLY AND INTERACTIVELY RESPOND TO VESSEL ACCIDENT

(71) Applicant: Korea Institute of Ocean Science & Technology, Ansan (KR)

(72) Inventors: Hee-Jin KANG, Gyeryong (KR); Dong-Kon LEE, Daejeon (KR); Jin CHOI, Gyeryong (KR)

(21) Appl. No.: 15/475,058

(22) Filed: Mar. 30, 2017

(30) Foreign Application Priority Data
Mar. 31, 2016 (KR) 10-2016-0038998

(51) Int. Cl. G06F 3/0488

(52) U.S. Cl. CPC G06F 3/04886; B63B 69/00

(57) ABSTRACT

The present invention generally relates to a system using an accident scenario and coded short keys to rapidly and interactively respond to a vessel accident capable of effectively responding to the vessel accident by use of coded shortcut keys when a vessel accident occurs.

### CROSS REFERENCE TO RELATED APPLICATION

The present application claims priority to Korean Patent Application No. 10-2016-0038998, filed Mar. 31, 2016, the entire contents of which is incorporated herein for all purposes by this reference.

### BACKGROUND OF THE INVENTION

### Field of the Invention

The present invention generally relates to a system using an accident scenario and coded short keys to rapidly and interactively respond to a vessel accident enabling an efficient response to a vessel accident by use of the coded shortcut keys when a vessel accident occurs.

Description of the Related Art

Generally, in order to respond to fire or flooding accidents occurring in vessels, a variety of accident response systems or damage control systems are utilized to minimize injury to of people, damage to the environment and property, and to maintain functions of vessels.

In order to efficiently respond to an accident on a vessel, the accident response systems perform checking, responding, and controlling operations of the accident scene through sensors associated with a large sized display of a console thereby the fire suppression team in the accident scene and the bridge or the commander of a machinery control room that is away from the accident scene may organically cooperate.

Contents reported during the accident response process are recorded through an input means such as keyboard of the accident response system and through specific accident response indication symbols. In addition, contents of accident response directions are recorded through the same method.

However, input methods of clicking a plurality of complex menu items displayed on an accident response system console by using a trackball or mouse or of inputting texts by using keyboard require precise and time-consuming operations in emergency situation. Thus, there is a problem that it is difficult to follow accidents that progress rapidly.

In order to solve the above problem, conventionally, accident response systems of vessels and related techniques have been developed.

Korean Patent No. 10-1005864 (2010 Dec. 28) discloses a method of reproducing and displaying accident data of a voyage data recorder for a vessel, and Korean Patent No. 10-1123488 (2012 Feb. 27) discloses an active security system for preventing a fire and leaking of a ship.

However, such a conventional method and system is problematic in that a concept of responding to accidents by using coded shortcut keys is not applied thereto.

Accordingly, conventionally, since shortcut keys are not used for provided interactive kill cards, it is not possible to respond the accident by sequentially inputting unit accident information of the corresponding accident. In addition, efficiency and speed of accident response system may be decreased.

In addition, conventionally, communication efficiency decreases since an amount of data to be transmitted is increased when contents of event information and unit accident information and control information are transmitted to the terrestrial support team or to the marine support team.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) Korean Patent No. 10-1005864

(Patent Document 2) Korean Patent No. 10-1123488

### SUMMARY OF THE INVENTION

An object of the present invention is to provide a system using an accident scenario and coded short keys to rapidly and interactively respond to a vessel accident that enables an efficient response to a vessel accident by use of the coded shortcut keys when an accident occurs on board.

In the preferred embodiment, the present invention provides a system using an accident scenario and coded short keys to rapidly and interactively respond to a vessel accident.

The system using the accident scenario and the coded short keys to rapidly and interactively respond to the vessel accident, includes: a set unit, in which unit accident information according to a typical accident order is set as different event information; an input unit for input of any one of the set event information and for sequential input of unit accident information included in the input event information; a response request unit for provision of accident response information associated with the input unit accident information to outside; and a storage unit for storage of the accident response information associated with the input unit accident information.

The sequential input of the unit accident information may be is input to the input unit by repeatedly inputting external input signals.

The input unit may include multiple shortcut keys displayed on a user display for selecting the different event information, and the repeated inputting of external input signals is performed by repeatedly and respectively pressing or touching the shortcut keys.

The input unit may check whether or not the input unit accident information respectively matches with the set unit accident information, and when the input unit accident information does not match with the set unit accident information, the input unit may generate an input error signal.

The multiple shortcut keys may be configured with touch keys displayed on the user display.

The touch keys may respectively display figure information visualizing the event information.

The response request unit may include a chat window displayed on the user display, and the accident response information may be input to the chat window and may be transmitted to an external request institute.

The chat window may receive support information from the external request institute.

The response request unit may generate an emergency code including the input event information and the unit accident information that is sequentially input, and transmit the generated emergency code to the external request institute.

The storage unit may capture and store the accident response information associated with the input unit accident information, input time thereof, and the user display.

The input unit may include a cancel unit, and the cancel unit may cancel the input event information and the input unit accident information.

The present invention improves efficiency and speed of the accident response system by sequentially inputting unit accident information of the corresponding accident event information to direct the accident scene by using shortcut keys associated with provided interactive kill cards, thereby the commander of the bridge may communicate clear objectives to the accident response team.

In addition, the present invention may dramatically reduce an amount of data to be transmitted and improve communication efficiency by configuring the event information and contents of the response information associated with the unit accident information in simplified emergency codes based on the shortcut keys and by transmitting the simplified emergency codes to the terrestrial support team or to the marine support team by using a communication means such as VHF, etc.

In addition, the present invention may be used for evaluating and improving accident response training on vessels, for efficiently analyzing an actual accident response result, and for continuously improving accident response scenarios according to a vessel type and route.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and other advantages of the present invention will be more clearly understood from the following detailed description when taken in conjunction with the accompanying drawings, in which:

FIG. 1 is a block diagram showing a system using an accident scenario and coded short keys to rapidly and interactively respond to a vessel accident;

FIG. 2 is a view showing the shortcut keys according to the present invention;

FIG. 3 is a view showing a user display according to the present invention;

FIG. 4 is another view showing the user display according to the present invention;

FIG. 5 is a view showing an example of a main fire extinguishing area displayed on the user display according to the present invention;

FIG. 6 is a view showing coded accident responses and support request information, and functions of storing event time and a screen; and

FIG. 7 is a view showing an example in which an interactive kill card situation is displayed on the user display according to the present invention.

FIGS. 8a to 8m are showing shortcut keys according to the present invention.

### DETAILED DESCRIPTION OF THE INVENTION

Hereinbelow, a system using an accident scenario and coded short keys to rapidly and interactively respond to a vessel accident will be described in detail with reference to the accompanying drawings.

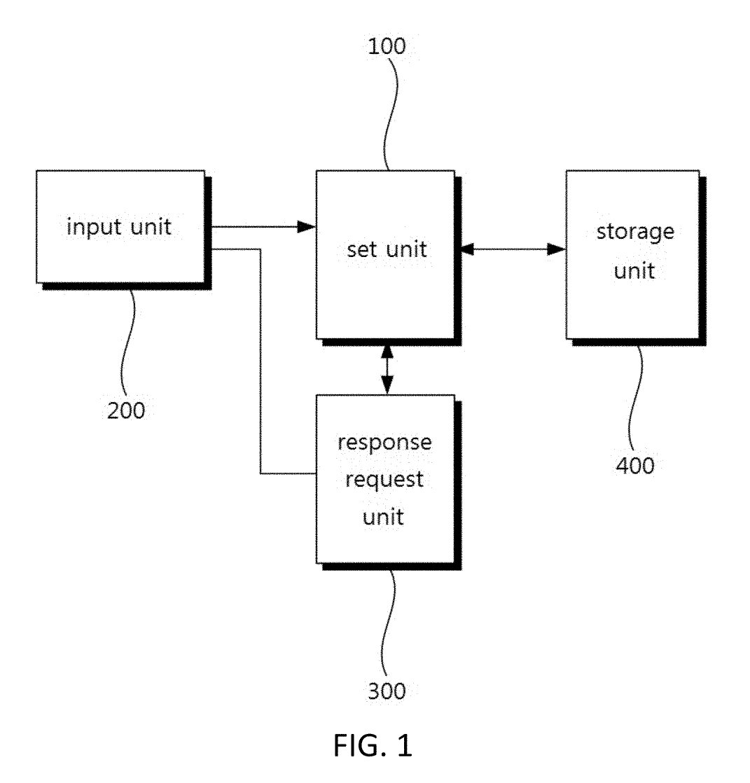

FIG. 1 is a block diagram showing a system using an accident scenario and coded short keys to rapidly and interactively respond to a vessel accident.

A configuration of the system using the accident scenario and the coded short keys to rapidly and interactively respond to the vessel accident will be described in detail with reference to FIG. 1.

The system using the accident scenario and the coded short keys to rapidly and interactively respond to the vessel accident of the present invention includes a set unit 100, an input unit 200, a response request unit 300, and a storage unit 400.

In the set unit 100, unit accident information according to a typical accident order is set as different event information.

Any one of the set event information and sequential input. of unit. accident information included in the input event information may be input through the input unit 200.

The sequential input of the unit accident information may be performed by repeatedly inputting external input signals.

The input unit 200 includes multiple shortcut keys that are displayed on a user display for selecting the different event information.

In addition, inputting of the external input signals may be performed by repeatedly and respectively pressing or touching the shortcut keys.

In addition, the input unit 200 may check whether or not the input unit accident information respectively matches with the set unit accident information, and when the input unit accident information does not match with the set unit accident information, the inputting unit 200 may generate an input error signal. The multiple shortcut keys are configured with touch keys that are displayed on the user display.

In addition, figure information that visualizes respective event information is displayed on each touch key.

In addition, the response request unit 300 according to the present invention may provide accident response information associated with the input unit accident information to outside.

The response request unit 300 includes a chat window displayed on the user display, and the accident response information may be input to the chat window and transmitted to an external request institute.

Herein, support information may be transmitted from the external request institute through the chat window.

The response request unit 300 may generate an emergency code including the input event information and the sequentially input unit accident information, and transmit the generated emergency code to the external request institute.

The storage unit 400 according to the present invention may store the accident response information associated with the input unit accident information.

The storage unit 400 may capture and store the accident response information associated with the input unit accident information, input time thereof, and the user display.

The input unit 200 includes a cancel unit.

The cancel unit generates a cancel signal through a cancel button. The cancel unit may cancel the input event information and information about the input unit accident information.

Next, operations of the system using the accident scenario and the coded short keys to rapidly and interactively respond to the vessel accident and being configured as described above will be sequentially described.

Input Unit (200)

The input unit according to the present invention includes the coded shortcut keys that are used for inputting situational information and directing an accident control by provided interactive kill cards.

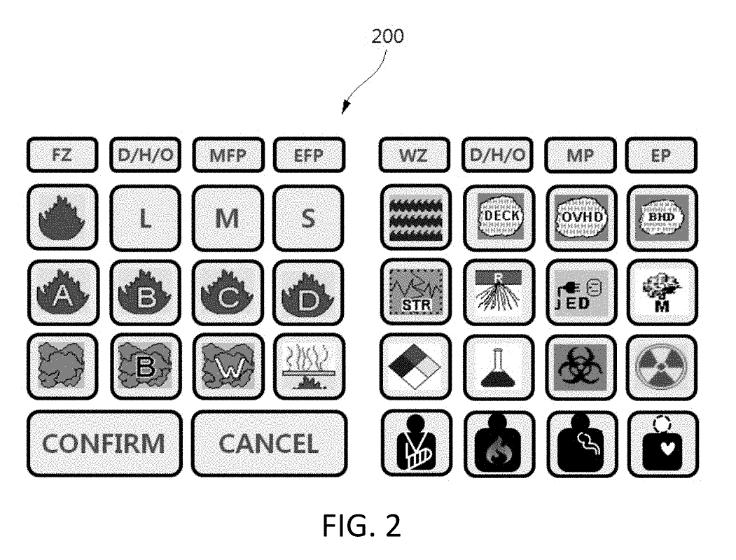

FIG. 2 is a view showing the shortcut keys according to the present invention.

Referring to FIG. 2, a multi-functional shortcut key usage example in which one-touch input is available for an accident response process based on a time sequence will be described.

In case of fire accident response, an A-class fire is recognized by inputting once shortcut key A.

Then, by inputting once again shortcut key A, shortcut key B indicating that the A-class fire is extinguished is displayed.

Then, by inputting once again shortcut key A, shortcut key C indicating that the A-class fire suppression is completed is displayed.

In addition, in case of occurrence of human injury, n number of persons having bone fracture is stored by inputting shortcut key D n-th times.

In addition, in case of occurrence of persons who suffocated, n number of suffocated persons is stored by inputting shortcut key E n-th times.

Meanwhile, a misoperation and input error prevention key and a function thereof will be described. An input process is performed by inputting a corresponding shortcut key and a ‘Confirm’ button.

For example, in case of a fire accident, the following buttons have to be sequentially input, shortcut key A=>shortcut key F.

In addition, describing the misoperation and input error prevention key and the function thereof, in order to cancel the input that is performed by inputting the corresponding shortcut key and the ‘Confirm’ button, a ‘Cancel’ button and the ‘Confirm’ button are sequentially input.

For example, in order to cancel the fire accident, the following buttons have to be sequentially input, shortcut key A=>shortcut key F=>shortcut key G=>shortcut key F.

As described above, in the present invention, there is an effect of sequentially inputting an accident responding process in a time sequence using a single shortcut key while responding to the accident whereby “Accident occurrence” is input by inputting a corresponding coded shortcut key, “Responding to accident” is input by inputting again the corresponding coded shortcut key, and “Accident response completed” is input by inputting again the corresponding coded shortcut key.

In addition, the present invention includes a misoperation and input error prevention key and a function thereof that verify an input to prevent an input error and misoperation of the coded shortcut key.

In addition, the present invention includes an input information cancelation key and a function thereof for canceling a wrong or mistaken input when a misoperation and input error has occurred.

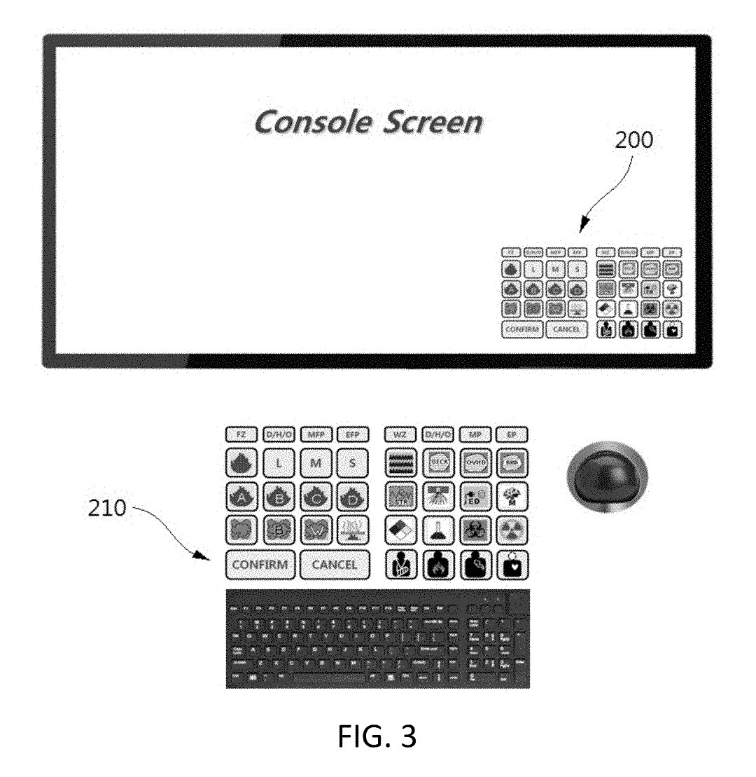

FIG. 3 is a view showing a user display according to the present invention. In other words, FIG. 3 shows an arrangement state of the coded shortcut keys displayed on a console hardware and on a GUI.

In addition, as shown in FIG. 3, the present invention includes an accident response system operation console including the coded shortcut keys for operating the accident response system using the coded shortcut keys.

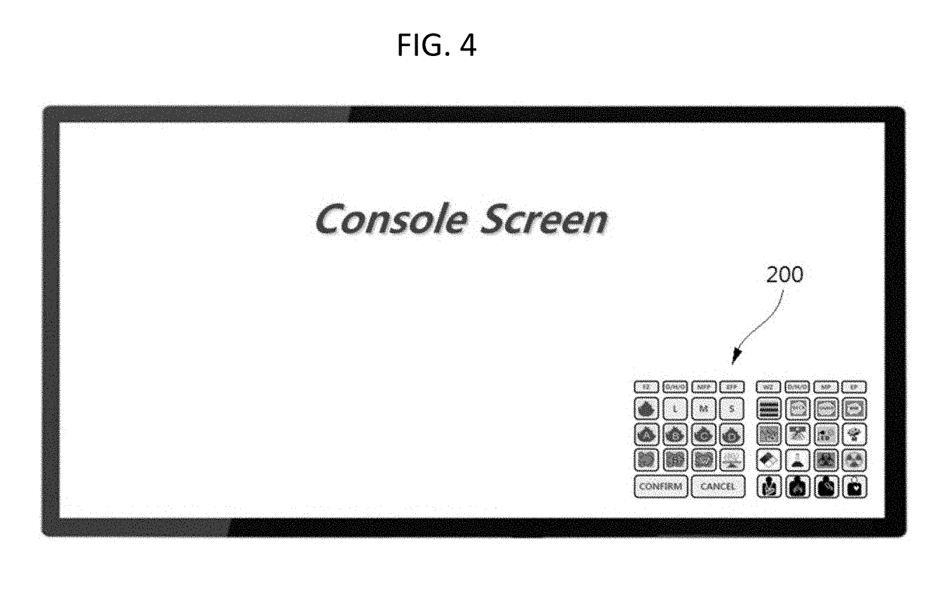

In addition, as shown in FIG. 4, the present invention may display the coded shortcut keys on the user display and include operational functions thereof.

In addition, the present invention may include a function of “displaying and operating coded shortcut keys on the GUI” that is capable of operating the coded shortcut keys and the accident response system by using other input devices 210 such as keyboard, trackball, mouse, etc. and by using a console screen (GUI, Graphic user interface) when coded shortcut keys of an external console are not usable due to external impact, failure, etc.

In addition, referring to FIG. 4, a function of simply displaying specific information on a screen such as shortcut key H, a main fire extinguishing area is displayed by inputting shortcut key H without inputting shortcut key F, and is canceled displaying the main fire extinguishing area by inputting shortcut key H once again.

Response Request Unit 300 and Storage Unit 400

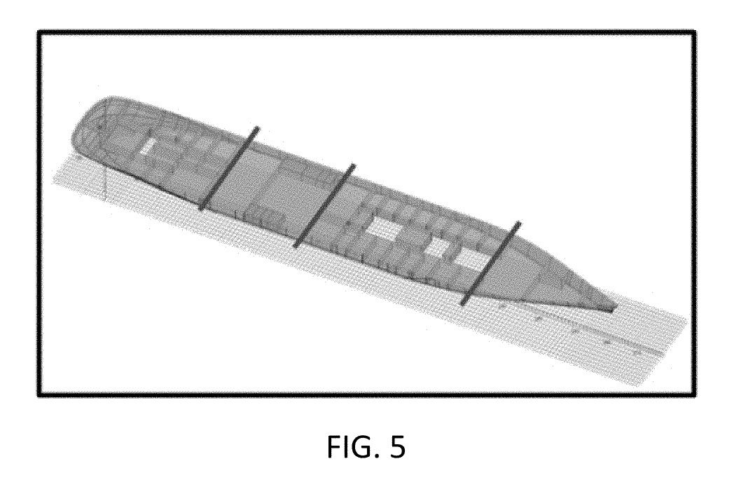

FIG. 5 is a view showing an example of a main fire extinguishing area displayed on the user display according to the present invention.

Referring to FIG. 5, in the present invention, coded accident responses and support request information, event time and a screen may be recorded.

Based on input time of the coded shortcut key displayed on the user display, before and after voices, CCTV images and the progress state displayed on the GUI may be recorded and stored in the storage unit 400 that is a recording medium of the vessel.

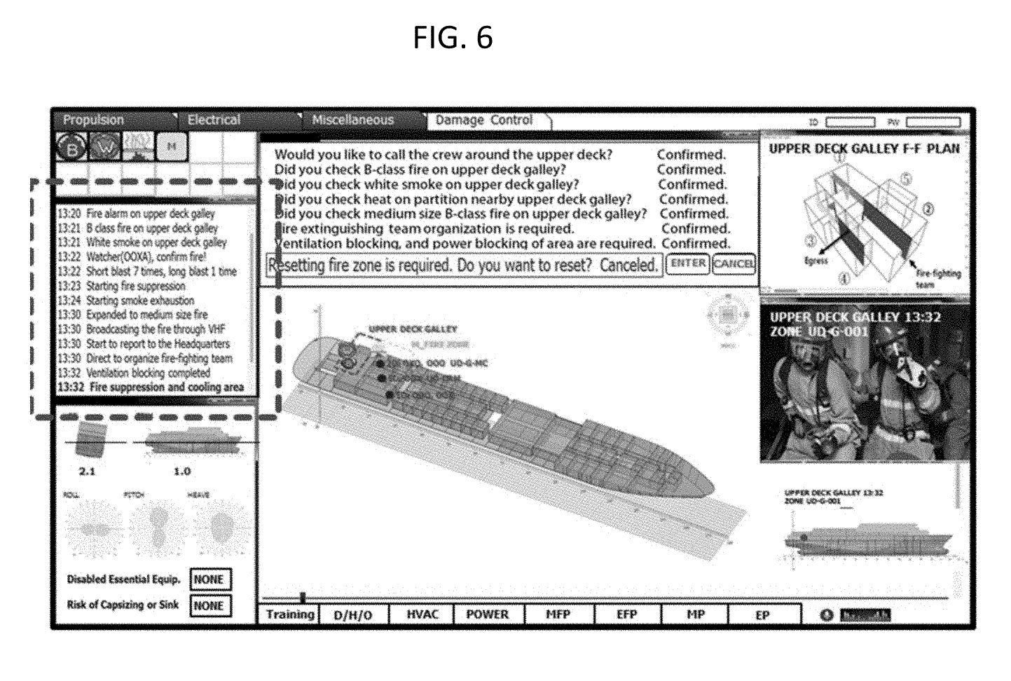

FIG. 6 is a view showing coded accident responses and support request information, and functions of storing event time and the screen.

In addition, referring to FIG. 6, while informing of the vessel accident and a response progress thereof to neighboring vessels and to the land, accident progress records of accident response records (within the red squared) displayed on the user display may be recorded and stored by simply coding the records based on the coded shortcut keys, and transmitted to the neighboring vessels and to the land to be used for requesting helps through a very high frequency (VHF) channel.

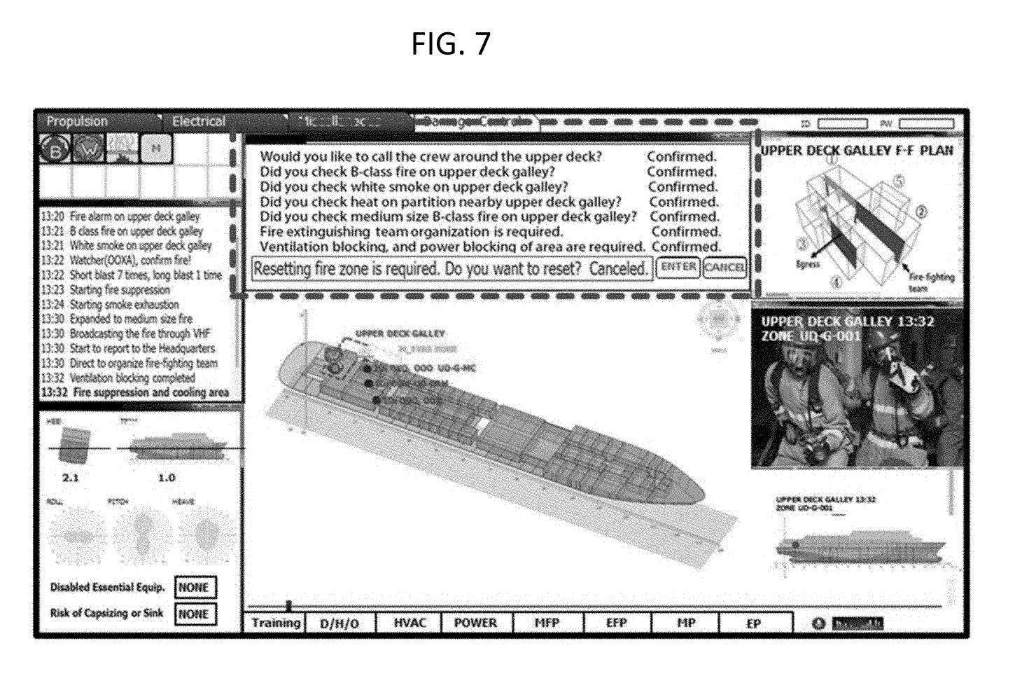

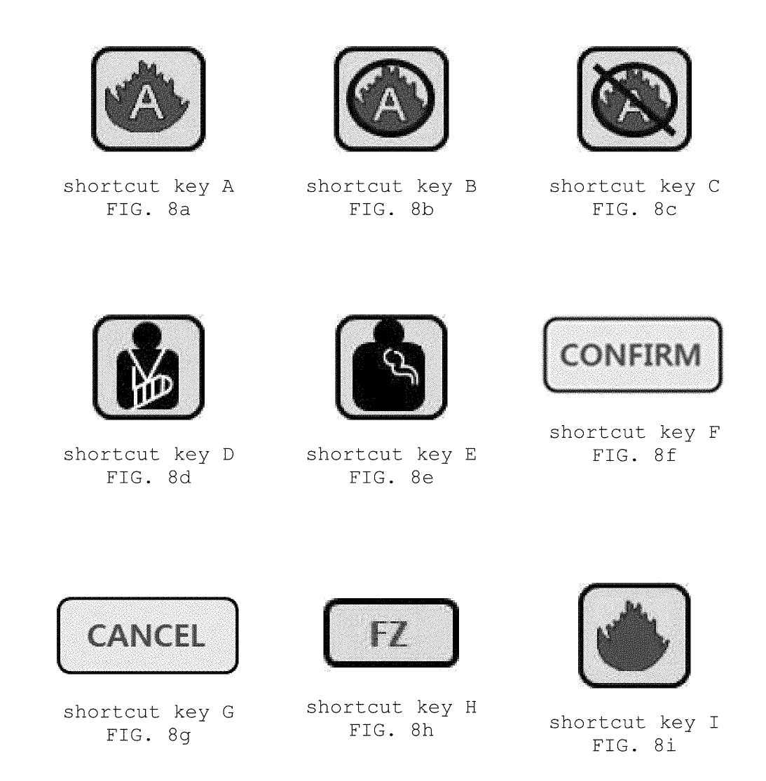

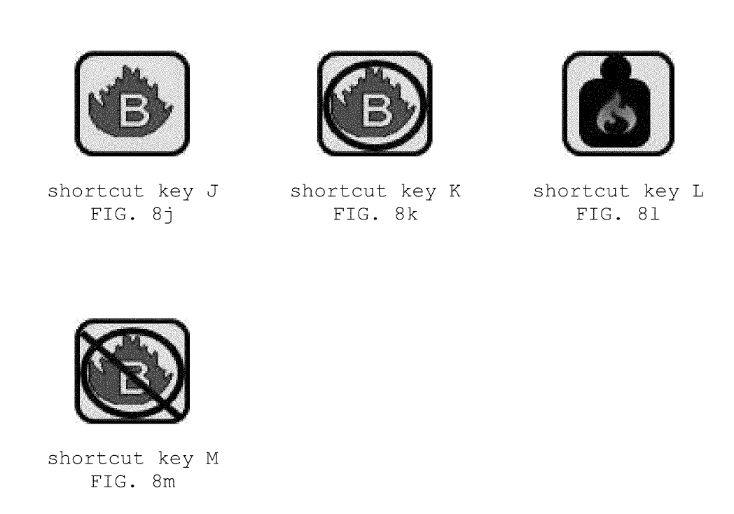

FIG. 7 is a view showing an example in which an interactive kill card situation is displayed on the user display according to the present invention.

The present invention may draw up an accident response report and a training analysis report.

In other words, the accident progress records of the accident response records (within the red square) may be recorded and stored by simply coding the records based on the coded shortcut keys. The recorded code may be used for determining timing of the accident, appropriateness and necessity of supplement of response content, and may be used for a training scenario, and for a correction and supplement of an accident response plan.

For example, the accident responses may be performed in the following sequence.

Screen: There was a fire in the upper deck galleys. Did you check?

Coded shortcut key: Checking “Fire occurrence” by inputting shortcut key I and shortcut key F.

Screen: Would you like to call the crew nearby the accident scene?

Coded shortcut key: Calling the crew through a system by inputting shortcut key F.

Screen: Did you identify the crew's report and a fire type with CCTV?

Coded shortcut key: Checking “B-class fire” by inputting shortcut key J and shortcut key F.

Screen: Is the fire under control?

(Fire hydrant position and an entry thereof are checked through CCTV, voice, etc.)

Coded shortcut key: Checking “Fire being handled” by inputting shortcut key K and shortcut key F.

(Occurrence of two burn victims in the fire zone being reported through a voice report while managing the fire)

Coded shortcut key: Checking the number of burn patients by repeatedly inputting shortcut key L as the number of burn victims and by inputting shortcut key F. (Information about the burn victims is coded and transmitted to neighboring vessels and to the land to be used for preparing for help)

Screen: Has the fire been extinguished?

Coded shortcut key: Checking that the “Fire suppression is completed” by inputting shortcut key M and shortcut key F.

In addition, the present invention includes a function of wirelessly transmitting the coded accident responses and the support request information.

In other words, the above function functions to simply code the accident progress records of the above accident response records (within the red square) and to transmit the generated code by using a communication device of the vessel.

The embodiment of the present invention configured according to the above configuration and operations may direct the accident scene by enabling sequential input of unit accident information of corresponding accident event information by using shortcut keys associated with provided interactive kill cards. Accordingly, efficiency and speed of the accident response system may be improved, the commander of the bridge may communicate clear objectives to the accident response team.

In addition, the embodiment according to the present invention may dramatically reduce an amount of data to be transmitted and improve communication efficiency by configuring event information, and contents of response information associated with unit accident information in simplified emergency codes based on shortcut keys and by transmitting the simplified emergency codes to the terrestrial support team or to the marine support team by using a communication means such as VHF, etc.

In addition, the embodiment according to the present invention may be used for evaluating and improving accident response training on vessels, for efficiently analyzing an actual accident response results, and for continuously improving accident response scenarios according to a vessel type and route.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A system using an accident scenario and coded short keys to rapidly and interactively respond to a vessel accident, the system comprising:
a set unit, in which unit accident information according to a typical accident order is set as different event information;
an input unit for input of any one of the set event information and for sequential input of unit accident information included in the input event information;
a response request unit for provision of accident response information associated with the input unit accident information to outside; and
a storage unit for storage of the accident response information associated with the input unit accident information.

2. The system of claim 1, wherein the sequential input of the unit accident information is input to the input unit by repeatedly inputting external input signals.

3. The system of claim 2, wherein the input unit includes multiple shortcut keys displayed on a user display for selecting the different event information, and the repeated inputting of external input signals is performed by repeatedly and respectively pressing or touching the shortcut keys.

4. The system of claim 3, wherein the input unit checks whether or not the input unit accident information respectively matches with the set unit accident information, and when the input unit accident information does not match with the set unit accident information, the input unit generates an input error signal.

5. The system of claim 3, wherein the multiple shortcut keys are configured with touch keys displayed on the user display.

6. The system of claim 5, wherein the touch keys respectively display figure information visualizing the event information.

7. The system of claim 3, wherein the response request unit includes a chat window displayed on the user display, and the accident response information is input to the chat window and is transmitted to an external request institute.

8. The system of claim 7, wherein the chat window receives support information from the external request institute.

9. The system of claim 7, wherein the response request unit generates an emergency code including the input event information and the unit accident information that is sequentially input, and transmits the generated emergency code to the external request institute.

10. The system of claim 7, wherein the storage unit captures and stores the accident response information associated with the input unit accident information, input time thereof, and the user display.

11. The system of claim 1, wherein the input unit includes a cancel unit, and the cancel unit cancels the input event information and the input unit accident information.
